(19) United States
(12) Patent Application Publication
(10) Pub. No.: US 2019/0144690 A1
(43) Pub. Date: May 16, 2019

(54) COATING

(71) Applicant: Energenics Europe Ltd, Begbroke, Oxfordshire (GB)

(72) Inventor: Yingqian XU, Begbroke, Oxfordshire (GB)

(21) Appl. No.: 16/300,151

(22) PCT Filed: May 12, 2017
(86) PCT No.: PCT/GB2017/051330

§ 371 Date: Nov. 9, 2018

(30) Foreign Application Priority Data
May 12, 2016 (GB) 1608332.1

(51) Int. Cl. C09D 5/32; C09D 7/40; C09D 5/00; G02B 5/00; G02B 1/04

(52) U.S. Cl. CPC C09D 5/32; C09D 7/67; C09D 7/68; C08K 2003/2213; G02B 5/003; G02B 1/04; C09D 5/002

(57) ABSTRACT

A coating composition or a polymer composition containing UV/HEV absorbing material has a ratio of electromagnetic radiation absorption at 450 nm to that at 320 nm of greater than 5%, preferably greater than 10% and more preferably greater than 20%. An additive for incorporation into a coating, or for incorporation into a polymer, comprises nanoparticles of cerium oxide in combination with at least one other metal oxide. The additive is configured so that the coating when applied to a surface, or the polymer, has a total absorption of at least 10% of electromagnetic radiation in a wavelength band between 400 nm and 500 nm. A wood coating comprising the additive, having a total absorption of at least 10% of electromagnetic radiation in a wavelength band between 400 nm and 500 nm, is also disclosed.

### TECHNICAL FIELD

The present invention relates to a coating composition or a polymer composition containing UV/HEV absorbing material to protect them from degradation caused by electromagnetic radiation. The present invention also relates to an additive for incorporation into a coating or a polymer for protecting materials from degradation caused by electromagnetic radiation. In particular, the invention relates to an additive for absorbing high energy visible light and a method of manufacture thereof.

### BACKGROUND

Materials such as wood and polymers can be damaged by prolonged exposure to light, especially ultra-violet (UV) light. This damage can range from discolouration to disintegration.

The damage caused by UV light may be reduced by the use of a UV absorber additive, applied as a coating or provided in the bulk of a product. Typically, wood or other surfaces are protected from UV damage by means of a coating which comprises organic UV absorbers, such as hydroxyphenyl benzotriazoles. However, organic UV absorbers tend to degrade over time and so only provide a limited amount of protection.

More recently, inorganic absorbers have been developed which do not degrade over time. These include metal oxides, such as ZnO, TiO₂ and CeO₂, which are semiconductors. It has been found that CeO₂ in combination with another metal oxide is particularly effective as an inorganic UV absorber.

However, although inorganic UV absorbers overcome many of the issues with organic absorbers, they still do not entirely prevent the damage caused to wood and other materials by exposure to light.

### SUMMARY

According to one aspect of the present invention there is provided a coating composition containing UV/HEV (HEV=High Energy Visible Light) absorbing material, and having a ratio of electromagnetic radiation absorption at 450 nm to that at 320 nm of greater than 5%, preferably greater than 10% and more preferably greater than 20%.

According to another aspect of the present invention, there is provided a polymer composition containing UV/HEV absorbing material, and having a ratio of electromagnetic radiation absorption at 450 nm to that at 320 nm of greater than 5%, preferably greater than 10% and more preferably greater than 20%.

The coating composition or the polymer composition of the aspects above may contain UV/HEV absorbing material comprising nanoparticles of cerium dioxide in combination with at least one other metal oxide. The ratio of the other metal oxide to cerium oxide may be from 0.5:99.5 to 50:50, preferably 5:95 to 40:60 and more preferably 10:90 to 30:70. The other metal oxide may be selected from oxides of Fe, Mn, Cu and Co, or any combination thereof.

According to another aspect of the present invention, there is provided a coating composition having a ratio of UV/HEV absorbing material to non-volatile organic components of the coating composition from 0.05:99.95 to 10.0:90.0, preferably from 0.1:99.9 to 8.0:92.0 and more preferably from 0.2:99.8 to 6.0:94.0.

According to another aspect of the present invention, there is provided a substrate coated with the coating composition of the aspects above. The substrate may be one of: plastic, glass, stone, masonry, brick, concrete, wood, metal, textile, composite.

According to another aspect of the present invention, there is provided a UV/HEV absorbing material configured such that, when incorporated into a coating, a ratio of the coating's electromagnetic radiation absorption at 450 nm to that at 320 nm is greater than 5%, preferably greater than 10% and more preferably greater than 20%. The UV/HEV absorbing material may comprise nanoparticles of cerium dioxide in combination with at least one other metal oxide.

According to another aspect of the present invention, there is provided a polymer composition having a ratio of UV/HEV absorbing material to non-volatile organic components of the polymer from 0.01:99.99 to 10.0:90.0, preferably from 0.1:99.9 to 8.0:92.0 and more preferably from 0.2:99.8 to 6.0:94.0.

According to another aspect of the present invention, there is provided a UV/HEV absorbing material configured such that, when incorporated into a polymer, a ratio of the polymer's electromagnetic radiation absorption at 450 nm to that at 320 nm is greater than 5%, preferably greater than 10% and more preferably greater than 20%. The UV/HEV absorbing material may comprise nanoparticles of cerium dioxide in combination with at least one other metal oxide.

According to another aspect of the present invention there is provided an additive for incorporation into a coating, comprising nanoparticles of cerium oxide in combination with at least one other metal oxide, the additive configured so that the coating when applied to a surface has a total absorption of at least 10% of electromagnetic radiation in a wavelength band between 400 nm and 500 nm.

According to another aspect of the present invention there is provided an additive for incorporation into a polymer, comprising nanoparticles of cerium oxide in combination with at least one other metal oxide, the additive configured so that the polymer has a total absorption of at least 10% of electromagnetic radiation in a wavelength band between 400 nm and 500 nm.

The total absorption of the coating when applied to the surface or the total absorption of the polymer may be at least 20%, preferably at least 30%, more preferably at least 40% and most preferably at least 50% of electromagnetic radiation in a wavelength band between 400 nm and 500 nm.

The total absorption of the coating when applied to the surface or the total absorption of the polymer may be at least 90% of electromagnetic radiation in a wavelength band between 300 nm and 400 nm, and at least 10%, preferably at least 20%, preferably at least 30%, more preferably at least 40% and most preferably at least 50% of electromagnetic radiation in a wavelength band between 400 nm and 500 nm.

The total absorption of the coating when applied to the surface or the total absorption of the polymer may be at least 10%, preferably at least 20%, preferably at least 30%, more preferably at least 40% and most preferably at least 50% of electromagnetic radiation in a wavelength band between 400 nm and 450 nm.

Cerium oxide in combination with at least one other metal oxide may be present in the additive in the range of 1 wt % to 90 wt %, more preferably in the range of 2 wt % to 75 wt % and more preferably in the range of 5 wt % to 50 wt %.

The other metal oxide may be at least 0.5%, more preferably at least 1%, more preferably at least 2%, more preferably at least 5%, more preferably at least 10% and more preferably at least 20% of the total metal oxide mixture.

The coating or polymer resulting from the additive may not be colourless.

The coating or polymer resulting from the additive may be substantially transparent.

The at least one other metal oxide may be one of iron oxide, copper oxide, manganese oxide, cobalt oxide.

The nanoparticles may have an average size in the range of 1 nm to 500 nm. Preferably the nanoparticles may have an average size in the range of 5 nm to 200 nm.

The invention also provides a coating comprising an additive as described above. The coating may be designed for application with an intended thickness of between 0.1 and 500 μm, and preferably between 1 and 300 μm, and more preferably between 5 and 200 μm. The cerium oxide in combination with at least one other metal oxide may be present in the coating in the range 0.05 wt % to 10 wt %, preferably 0.2 wt % to 5 wt %.

The invention also provides a wood coating comprising an additive as described above. The coating may be designed for application with an intended thickness of between 10 and 500 μm and preferably between 20 and 200 μm. The cerium oxide in combination with at least one other metal oxide may be present in the coating in the range 0.05 wt % to 10 wt %, preferably 0.2 wt % to 5 wt %.

The invention also provides a polymer comprising an additive as described above. The cerium oxide in combination with at least one other metal oxide may be present in the polymer in the range 0.01 wt % to 10 wt %, preferably 0.1 wt % to 2 wt %.

The invention also provides a material comprising nanoparticles of cerium oxide combined with at least one other metal oxide, the material having a total absorption of at least 10% of electromagnetic radiation in a wavelength band between 400 nm and 500 nm.

According to a further aspect of the present invention, there is provided a method of manufacturing an additive comprising nanoparticles of cerium oxide in combination with at least one other metal oxide, the additive configured so that a coating or polymer incorporating said additive has a total absorption of electromagnetic radiation between 400 nm and 500 nm of at least 10%, the method comprising: forming a precipitate in a liquid; washing and purifying the precipitate and optionally drying the precipitate; and dispersing the precipitate in a carrier media.

According to another aspect of the present invention, there is provided a coating applied to a material for protecting said material against degradation caused by electromagnetic radiation, the coating comprising nanoparticles of cerium oxide in combination with at least one other metal oxide and being configured to absorb electromagnetic radiation spanning the UV and HEV wavelength ranges.

The invention also provides a primer coating composition having a ratio of UV/HEV absorbing material to non-volatile organic components of the primer coating composition from 6.0:94.0 to 99.0:1.0, preferably from 10.0:90.0 to 90:10 and more preferably from 15.0:85 to 85:15.

The invention also provides a substrate coated with the above primer coating composition having a primer coating thickness from 0.1 to 40 microns, preferably from 0.5 to 30 microns and more preferably from 1 to 25 microns. The substrate may be subsequently coated with a topcoat having a thickness of from 1 to 500 microns.

The invention also provides a substrate prepared by application to the substrate of an aqueous or non-aqueous dispersion of the above additive. The applied dispersion of the additive may have an additive coating thickness of from 0.005 to 5.0 microns, preferably from 0.01 to 3.0 microns and more preferably from 0.02 to 2 microns. The substrate may be subsequently coated with a topcoat having a thickness of from 1 to 500 microns.

### BRIEF DESCRIPTION OF THE DRAWINGS

FIG. 1 is a graph illustrating UV and HEV light absorption by a selection of Ceria (CeO₂) and modified Ceria dispersions;

FIG. 2 is a graph illustrating UV and HEV light absorption by a selection of Ceria (CeO2) and modified Ceria dispersions, present at a higher w/v % than the dispersions shown in FIG. 1;

FIG. 3 is a graph illustrating UV and HEV light absorption by 0.01 wt % solvent dispersions with different additives;

FIG. 4 is a graph illustrating UV and HEV light absorption by 0.1 wt % solvent dispersions with different additives;

FIG. 5 is a graph illustrating UV and HEV light absorption by coating with different/no additives on a glass slide;

FIG. 6 is a graph illustrating UV and HEV light absorption by coating with different concentrations of/no additives on a glass slide; and

FIG. 7 is a flow chart illustrating a method of manufacture of an additive for incorporation into a coating, comprising nanoparticles of cerium oxide in combination with at least one other metal oxide.

### DETAILED DESCRIPTION

Previous work on the development of inorganic absorbers has focussed on how to extend the range of UV absorbance, particularly in the UVA band (315 nm to 400 nm). For example, it has been found that mixing CeO₂ nanoparticles with another metal oxide, such as iron oxide, increases the absorbance of UV light in the 350 nm to 400 nm range.

Absorbance beyond 400 nm, corresponding to light in the visible range (approximately 400 nm to 800 nm) has generally been considered to be undesirable because a coating containing the absorber would no longer be colourless. Since one purpose of this type of UV absorber is to prevent or reduce discolouration caused by exposure to light, it has been considered important that the UV absorber does not change the colour of the surface or bulk material to which it is applied. If a colour change was required, a coloured varnish, stain or pigment could be used instead. This is particularly true for wood surfaces, where a clear coating allows the true colour and grain of the wood to be seen.

The inventors have realised, however, that even where UV absorbance can be extended towards the end of the UVA range, i.e. up to 400 nm, damage caused by exposure to light still occurs. It has been surmised that this damage is caused by so-called high energy visible light (HEV), which is generally defined as visible light within the 400 nm to 500 nm wavelength range.

This view is supported by the fact that interior surfaces, such as wood floors, plastics and textiles, are damaged by prolonged exposure to light. This occurs even though standard window glass typically absorbs UV light up to around 350 nm. Window glass therefore filters out all of the UVB light and some of the UVA light. Any degradation to interior surfaces must therefore be caused by a combination of UVA and HEV light.

The inventors have discovered that a coating including an additive comprising nanoparticles of CeO₂ combined with another metal oxide (such as for example iron oxide, copper oxide, manganese oxide or cobalt oxide) can be optimised so that both UV and HEV light is absorbed. This can be achieved by optimising the ratio of other metal oxides, the concentration of nanoparticles, and/or the thickness of the coating when applied.

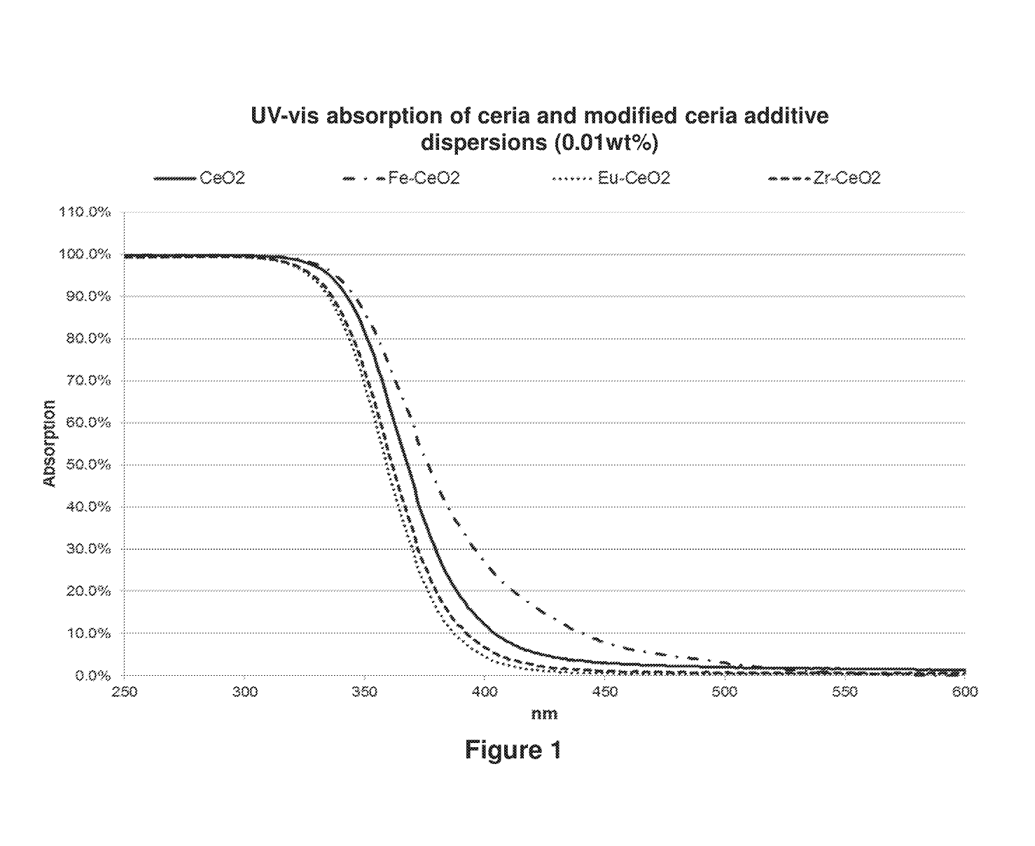

FIG. 1 illustrates UV and HEV light absorption by a selection of Ceria (CeO₂) and modified Ceria dispersions. The dispersions comprise CeO₂ alone, and CeO₂ modified with iron oxide, europium oxide, and zirconium oxide, respectively. The average total absorption (%) in the 400 nm to 500 nm range (i.e. the HEV range) for each of the dispersions is shown in Table 1 below:

TABLE 1

| | CeO₂ | Fe—CeO₂ | Eu—CeO₂ | Zr—CeO₂ |
|---|---|---|---|---|
| 400-450 nm | 5.74% | 15.57% | 1.58% | 2.71% |
| 450-500 nm | 2.44% | 5.11% | 0.48% | 0.90% |
| 400-500 nm | 4.10% | 10.37% | 1.03% | 1.81% |

In the example of FIG. 1, the nanoparticle dispersion comprises 0.01 w/v % CeO₂ or modified CeO₂. The cuvette path length was 10 mm. Using the Beer-Lambert Law, A=εbc, where A is absorbance, ε is the wavelength-dependent molar absorptivity coefficient, b is the path length of the sample (the path length of the cuvette) and c is the concentration of the compound in solution, this corresponds to a coating having cerium oxide or modified cerium oxide of 2% by weight in dry film, and a dry film or coating thickness of 50 μm (micron).

It will be appreciated that coatings such as paint typically have a “solids content” which is the dry residue after evaporation of the solvent. This “solids content” may comprise between 10% to 50% of the original coating and may include resins and the like. There are coating formulations which have less than 15% solid content, and there are also coating formulations which have more than 50% solid content, e.g. 60% or 70% solid content, or even 100% solid content. The thickness of the dry coating after evaporation depends upon how the coating is applied. Generally, coatings for application to a surface are supplied with instructions for application, which may include a defined thickness (e.g. grams of film per square metre). In this way, an optimum coating thickness, and therefore an average total absorption, is specified for the user.

For example, in Table 1 above, cerium oxide in combination with iron oxide provides a total absorption of at least 10% of electromagnetic radiation in a wavelength band between 400 nm and 500 nm, where a dry coating of 50 μm thickness has modified cerium oxide at 2% by weight. The Fe—CeO2 sample shown in FIG. 1 is Ce_{0.8}Fe_{0.2}O₂.

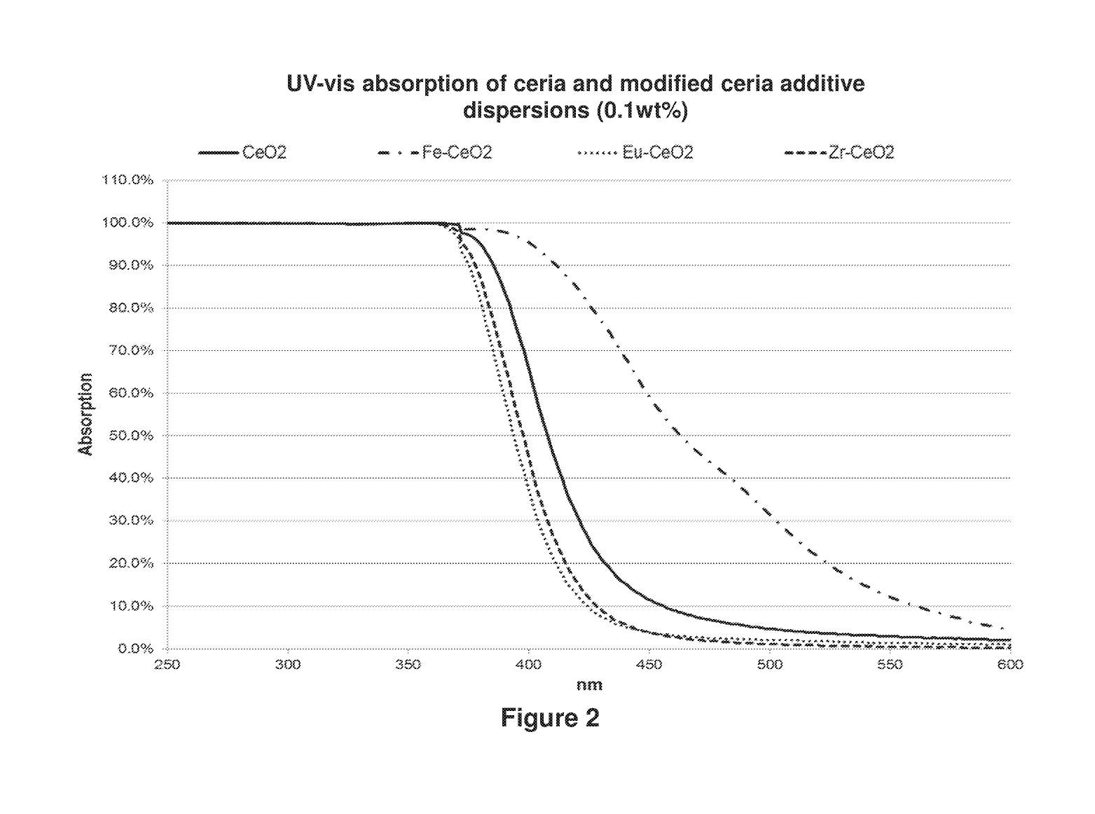

FIG. 2 illustrates a further example of UV and HEV light absorption by a selection of Ceria (CeO₂) and modified Ceria dispersions. The dispersions again comprised CeO₂ alone, and CeO₂ modified with iron oxide, europium oxide and zirconium oxide respectively. The average total absorption (%) in the 400 nm to 500 nm range (i.e. the HEV range) for each of the dispersions is shown in Table 2 below:

TABLE 2

| | CeO₂ | Fe—CeO₂ | Eu—CeO₂ | Zr—CeO₂ |
|---|---|---|---|---|
| 400-450 nm | 30.26% | 79.63% | 13.25% | 16.07% |
| 450-500 nm | 7.25% | 44.37% | 2.69% | 2.04% |
| 400-500 nm | 18.83% | 62.03% | 8.01% | 9.11% |

In the example of FIG. 2, the CeO₂ nanoparticle dispersion comprised 0.1 w/v % CeO₂. The cuvette path length was 10 mm. Again, using the Beer-Lambert Law, this corresponds to a coating having cerium oxide or modified cerium oxide of 2% by weight in dry film, and a dry film or coating thickness of 500 μm (micron). The Fe—CeO2 sample shown in FIG. 2 is Ce_{0.8}Fe_{0.2}O₂.

In both of these illustrated examples it can be seen that an additive comprising Fe—CeO2 has an average total absorption of at least 10% of light between 400 nm and 500 nm (HEV light). Depending upon the concentration of modified cerium oxide and the thickness of the dry coating, the total absorption of a coating incorporating the additive, when applied to a surface, may be at least 10%, preferably 20%, more preferably at least 30%, more preferably at least 40% and most preferably at least 50% of electromagnetic radiation in a wavelength band between 400 nm and 500 nm.

It can also be seen that the average total absorption of light in the 400 nm to 450 nm range is even higher, for example, at least 10%, preferably 20%, preferably 30%, more preferably 40% and most preferably 50%.

While the formulation described above provides effective protection against degradation caused by HEV light, it also provides protection against damage caused by UV light. In FIG. 1, for example, it can be seen that the formulation of modified cerium oxide absorbs at least 90% of electromagnetic radiation in a wavelength band between 300 nm and 400 nm, in addition to at least 10% of electromagnetic radiation in a wavelength band between 400 nm and 500 nm. A single additive, which may be incorporated into a coating or into the bulk of a material, such as a polymer, can therefore prevent or at least reduce damage caused by a combination of UV and HEV light by absorbing electromagnetic radiation spanning the UV and HEV wavelength ranges.

The additive described with reference to FIGS. 1 and 2 above comprises nanoparticles of CeO₂ in combination with another metal oxide. The nanoparticles have an average size of between 1 nm and 500 nm, and preferably 5 nm to 200 nm. The particles may be prepared in a variety of ways, including but not limited to: precipitation, co-precipitation, homogenous precipitation, hydrothermal methods, solvothermal methods, mechanical milling, high energy milling, mechanochemical processing (MCP), spray pyrolysis, sol-gel methods including preparation of xerogels and aerogels, physical vapour deposition (PVD) and chemical vapour deposition (CVD). It will be appreciated that the additive itself comprises more than just nanoparticles: in practice the CeO₂ or modified CeO₂ nanoparticles will typically comprise approximately 20 wt %.

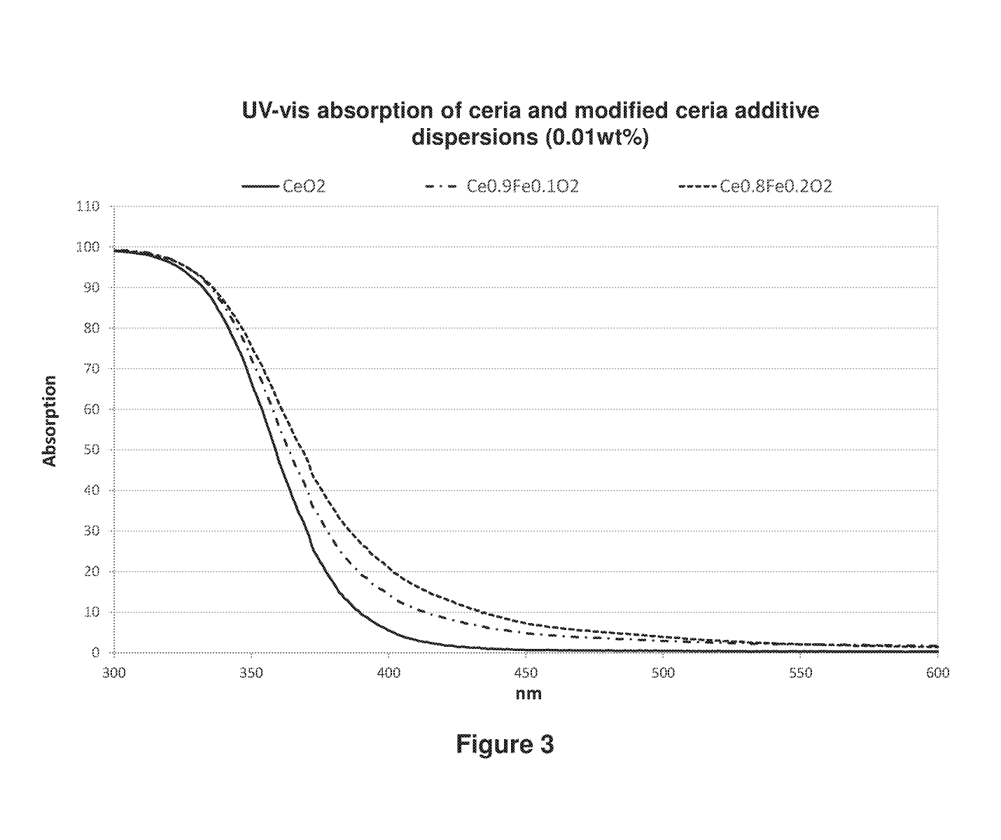

FIG. 3 is a graph illustrating the UV-vis spectra (i.e. the UV and HEV light absorption) of solvent dispersions with different additives. The dispersion in this illustrated example was 0.01% wt. The light absorption (A %) for solvent dispersions where the additive comprises nanoparticles of CeO₂, Ce_{0.9}Fe_{0.1}O₂ and Ce_{0.8}Fe_{0.2}O₂ are illustrated respectively. The additive in each case is prepared as described above with reference to FIGS. 1 and 2. The additive nanoparticles have the same average size as those described with reference to FIGS. 1 and 2. The UV-vis spectra were measured in a 1 cm quartz cell by the BioMate5, ThermoSpectronic spectrophotometer.

Table 3 below illustrates the % absorption of the solvent dispersions of FIG. 3. The ratio of absorption of 400 nm to 320 nm and of 450 nm to 320 nm is also provided. It can be seen that the 0.01 wt % dispersion of Fe_{0.2}Ce_{0.8}O₂ is the strongest absorber of HEV light at 450 nm and also provides the highest ratio of 450 nm/320 nm absorption.

TABLE 3

| | Absorption (%) | | | | |
|---|---|---|---|---|---|
| | | | | 400 nm/ | 450 nm/320 nm |
| sample | 320 nm | 400 nm | 450 nm | 320 nm (%) | (%) |

0.01 wt %

| | | | | | |
|---|---|---|---|---|---|
| UV- | 96.3 | 5.5 | 0.67 | 5.7% | 0.7% |
| absorber, | | | | | |
| CeO₂ | | | | | |
| UV/HEV- | 97.3 | 12.2 | 4.8 | 12.5% | 4.9% |
| absorber | | | | | |
| Fe_{0.1}Ce_{0.9}O₂ | | | | | |
| UV/HEV- | 97.1 | 21.0 | 7.2 | 21.6% | 7.4% |
| absorber | | | | | |
| Fe_{0.2}Ce_{0.8}O₂ | | | | | |

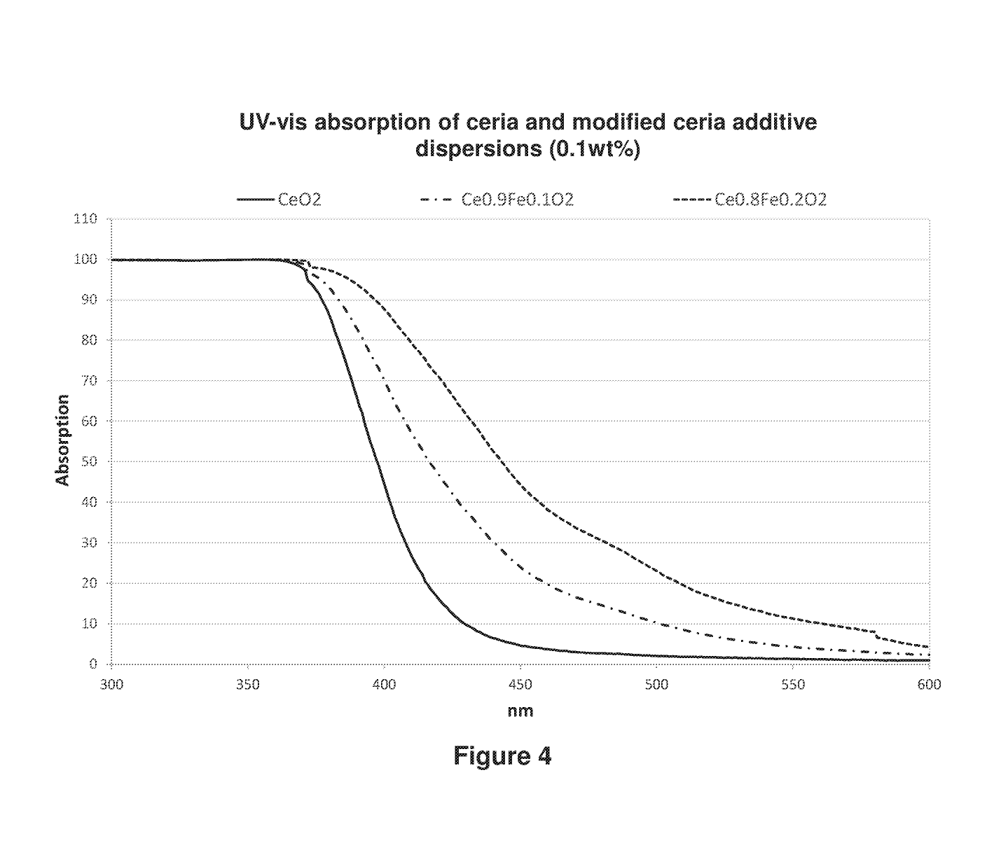

FIG. 4 is a graph illustrating the UV-vis spectra (i.e. the UV and HEV light absorption) of solvent dispersions with different additives. The dispersion in this illustrated example was 0.1% wt. The light absorption (A %) for solvent dispersions wherein the additive comprises nanoparticles of CeO₂, Ce_{0.9}Fe_{0.1}O₂ and Ce_{0.8}Fe_{0.2}O₂ are illustrated respectively. The additive in each case is prepared as described above with reference to FIGS. 1 and 2. The additive nanoparticles have the same average size as those described with reference to FIGS. 1 and 2. The UV-vis spectra were measured in a 1 cm quartz cell by the BioMate5, ThermoSpectronic spectrophotometer.

Table 4 below illustrates the % absorption of the solvent dispersions of FIG. 4. The ratio of absorption of 400 nm to 320 nm and of 450 nm to 320 nm is also provided. It can be seen that the 0.1wt % dispersion of Fe_{0.2}Ce_{0.8}O₂ is the strongest absorber of HEV light at 450 nm and also provides the highest ratio of 450 nm/320 nm absorption.

TABLE 4

| | Absorption (%) | | | | |
|---|---|---|---|---|---|
| | | | | 400 nm/ | 450 nm/320 nm |
| sample | 320 nm | 400 nm | 450 nm | 320 nm (%) | (%) |

0.1 wt %

| | | | | | |
|---|---|---|---|---|---|
| UV-absorber | 99.8 | 44.7 | 4.6 | 44.8% | 4.6% |
| CeO₂ | | | | | |
| UV/HEV- | 99.8 | 70.3 | 24.00 | 70.4% | 24.0% |
| absorber | | | | | |
| Fe_{0.1}Ce_{0.9}O₂ | | | | | |
| UV/HEV- | 99.8 | 87.0 | 43.6 | 87.2% | 43.7% |
| absorber | | | | | |
| Fe_{0.2}Ce_{0.8}O₂ | | | | | |

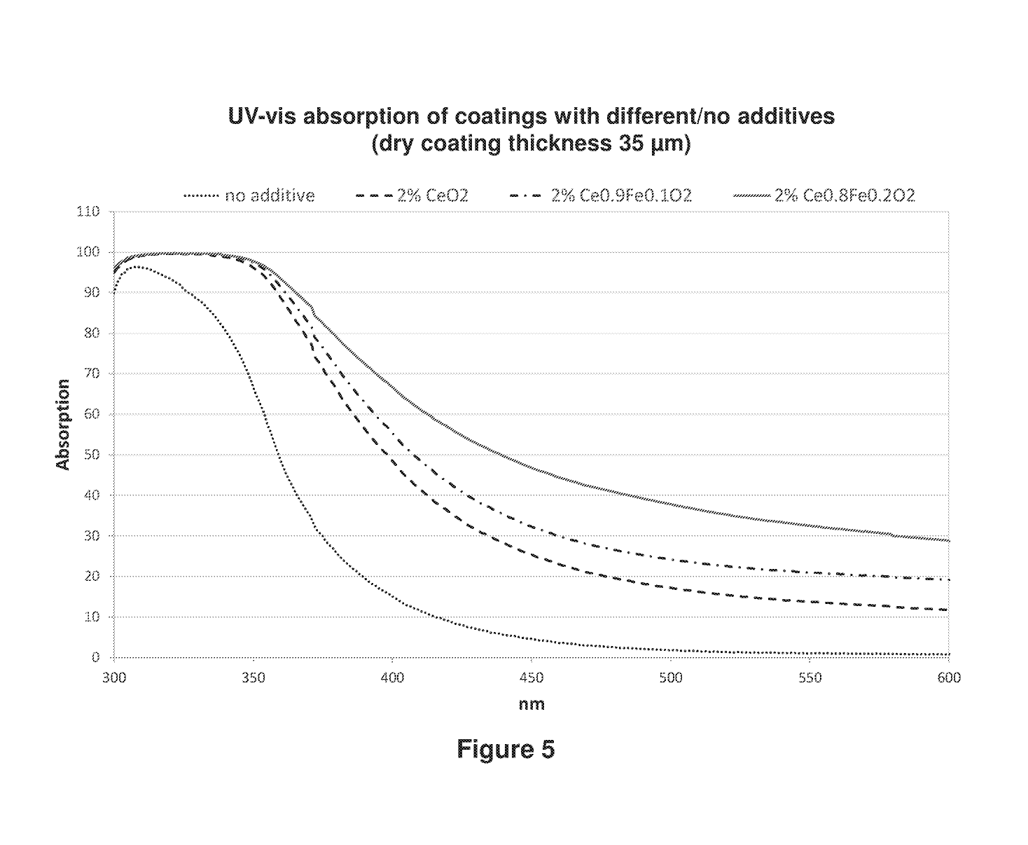

FIG. 5 is a graph illustrating the UV-vis spectra (i.e. the UV and HEV light absorption) of coatings with different additives. The coating in this illustrated example had a dry thickness of 35 μm and an additive concentration of 2%. The light absorption (A %) for coatings wherein the additive comprises nanoparticles of CeO₂, Ce_{0.9}Fe_{0.1}O₂ and Ce_{0.8}Fe_{0.2}O₂ are illustrated respectively, in addition to a coating comprising no additive. The additive in each case is prepared substantially as described above with reference to FIGS. 1 and 2. The additive nanoparticles have the same average size as those described with reference to FIGS. 1 and 2. The coatings were prepared with and without additive on the glass slides by a film applicator. The UV-vis spectra of the coatings were measured using a BioMate5, ThermoSpectronic spectrophotometer.

Table 5 below illustrates the % absorption of the coatings of FIG. 5 at 320 nm, 400 nm and 450 nm. The ratio of absorption of 400 nm to 320 nm and of 450 nm to 320 nm is also provided. It can be seen that the 2% additive concentration coating of Ce_{0.8}Fe_{0.2}O₂ is the strongest absorber of HEV light at 450 nm and also provides the highest ratio of 450 nm/320 nm absorption.

TABLE 5

| | concen- | Absorption (%) | | | | |
|---|---|---|---|---|---|---|
| | tration | | | | 400 nm/ | 450 nm/ |
| | of | 320 | 400 | 450 | 320 nm | 320 nm |
| sample | additive | nm | nm | nm | (%) | (%) |
| no absorber | — | 93.5 | 15.1 | 4.6 | 16% | 5% |
| UV-absorber | 2% | 99.6 | 48.5 | 25.4 | 49% | 26% |
| CeO₂ | | | | | | |
| UV/HEV- | 2% | 99.6 | 55.3 | 32.3 | 56% | 32% |
| absorber | | | | | | |
| Ce_{0.9}Fe_{0.1}O₂ | | | | | | |
| UV/HEV- | 2% | 99.7 | 67.2 | 46.8 | 67% | 47% |
| absorber | | | | | | |
| Ce_{0.8}Fe_{0.2}O₂ | | | | | | |

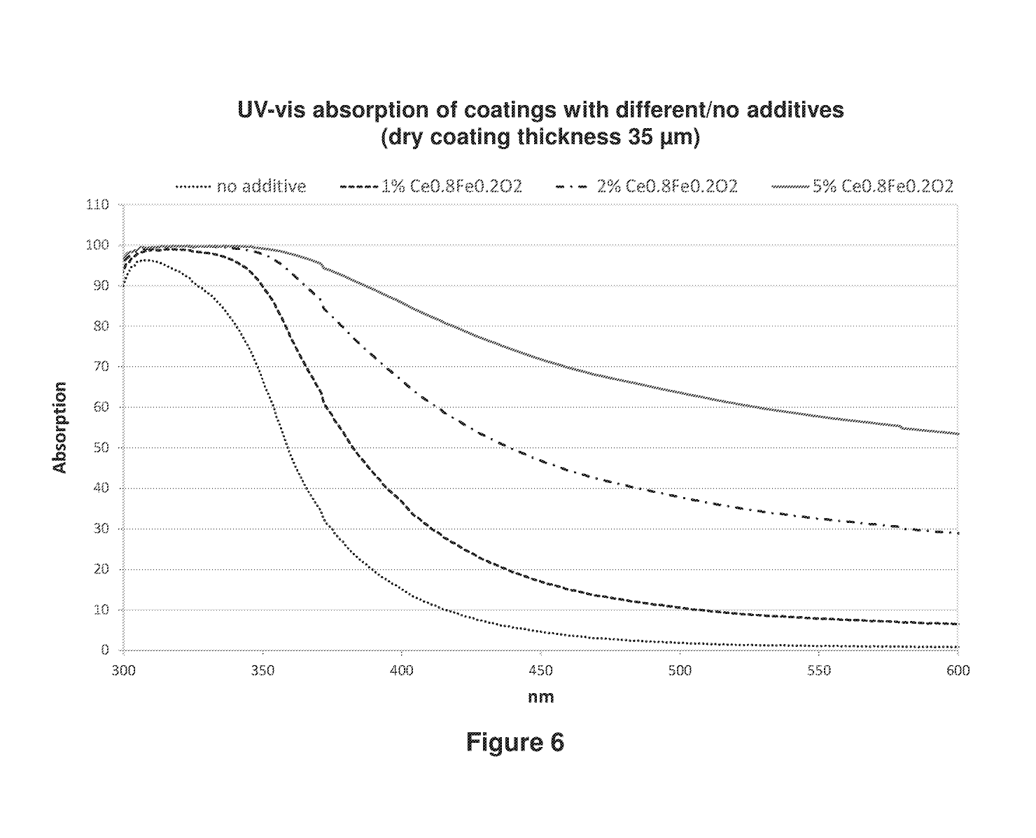

FIG. 6 is a graph illustrating the UV-vis spectra (i.e. the UV and HEV light absorption) of coatings with different concentrations of/no additives. The coating in this illustrated example had a dry thickness of 35 μm and additive concentration of between 1% and 5%. The light absorption (A %) for coatings wherein the additive comprises nanoparticles of Ce_{0.8}Fe_{0.2}O₂ at concentrations of 1%, 2% and 5% are illustrated respectively, in addition to a coating comprising no additive. The additive in each case is prepared substantially as described above with reference to FIGS. 1 and 2. The additive nanoparticles have the same average size as those described with reference to FIGS. 1 and 2. The coatings were prepared with and without additive on the glass slides by a film applicator. The UV-vis spectra of the coatings were measured using a BioMate5, ThermoSpectronic spectrophotometer.

Table 6 below illustrates the % absorption of the coatings of FIG. 6 at 320 nm, 400 nm and 450 nm. The ratio of absorption of 400 nm to 320 nm and of 450 nm to 320 nm is also provided. It can be seen that the 5% additive concentration coating of Ce_{0.8}Fe_{0.2}O₂ is the strongest absorber of HEV light at 450 nm and also provides the highest ratio of 450 nm/320 nm absorption.

TABLE 6

| | concen- | Absorption (%) | | | | |
|---|---|---|---|---|---|---|
| | tration | | | | 400 | 450 |
| | of | | | | nm/ | nm/ |
| | addi- | | | | 320 nm | 320 nm |
| sample | tive | 320 nm | 400 nm | 450 nm | (%) | (%) |
| no absorber | — | 93.5 | 15.1 | 4.6 | 16% | 5% |
| UV/HEV-absorber | 1% | 98.9 | 36.7 | 17.0 | 37% | 17% |
| Ce_{0.8}Fe_{0.2}O₂ | | | | | | |
| UV/HEV-absorber | 2% | 99.7 | 67.2 | 46.8 | 67% | 47% |
| Ce_{0.8}Fe_{0.2}O₂ | | | | | | |
| UV/HEV-absorber | 5% | 99.7 | 85.9 | 71.8 | 86% | 72% |
| Ce_{0.8}Fe_{0.2}O₂ | | | | | | |

It will be appreciated that an additive comprising nanoparticles (i.e. UV/HEV absorbing material), as described above, may also be incorporated into a polymer composition.

In order to measure the protection against degradation caused by UV and HEV light provided by the additives described above, three wood panels, A, B and C were coated with:

Panel A: a coating comprising no UV absorber;

Panel B: a coating comprising a UV absorber (CeO₂); and

Panel C: a coating comprising a UV/HEV absorber (modified CeO₂) i.e. Fe_{0.2}Ce_{0.8}O₂, as described above.

Each coating had a dry film thickness of about 100 μm, and where present, the additive, cerium oxide or modified cerium oxide (i.e. Fe_{0.2}Ce_{0.8}O₂) comprised about 2% by weight of the dry film.

The front of each panel was naturally weathered for a period of six years. In contrast, the backs of the panels were not exposed to weathering i.e. they were not exposed directly to elements such as sunlight. After this time, the change in colour of the front of each of the coated panels compared with the back was determined by an X-rite colour reflection spectrodensiometer.

The front of the wood panel with no UV absorber (panel A) became much lighter in colour (ΔL=+3.7) over the six year period in comparison to the rear, which had not been directly exposed to the sun. The front of the panels with UV absorber (panels B and C) became darker (ΔL −23.77 and −12.43 respectively). The total colour of the front of the panels without UV absorber (A) and with only UV-absorber changed quite significantly i.e. by ΔE=28.8 and 27.1 respectively. However, the front of the panel coated with a coating comprising UV/HEV-absorber (panel C) total colour changed less (ΔE=+18.4).

The changes in colour of each of the coated panels over the six year period are shown in Table 7 below:

An additive of nanoparticles of cerium oxide in combination with at least one other metal oxide, as described with reference to FIGS. 1 to 6 above, absorbs in both the UV and HEV bands. As a result of the absorption of some visible light, the additive will appear coloured. When the additive is incorporated into a wood coating, for example, the coating is therefore not colourless. In the examples illustrated above, the additive when incorporated into a wood coating imparts a substantially yellow tint to the surface of the wood. This yellow tint is due to the absorbance of visible light in the 400 nm to 500 nm range (blue light).

However, although the coating is not colourless, the inventors have found that an additive comprising modified cerium oxide in the concentrations specified herein is nevertheless substantially transparent. This transparent quality may be a result of the small size of the modified CeO₂ nanoparticles. Although the coating will impart a coloured tint to the surface on which it is applied, its transparency ensures that the surface itself is still visible. In the case of a wood coating, for example, the texture and grain of the wood is not obscured.

Further, because the additive provides protection against damage caused by both UV and HEV light, the colour of the coating will remain as originally applied and will not fade over time. This provides a significant advantage over conventional pigments and stains, where the eventual colour of the pigment or stain cannot always be reliably predicted.

The ratio of electromagnetic radiation absorption at 450 nm to that at 320 nm of a coating composition containing UV/HEV absorbing material, such as that described above, is greater than 5%, preferably greater than 10% and more preferably greater than 20%. Similarly, the ratio of electromagnetic radiation absorption at 450 nm to that at 320 nm of a polymer composition containing UV/HEV absorbing material, such as that described above, is greater than 5%, preferably greater than 10% and more preferably greater than 20%. In this example, the UV/HEV absorbing material contained in the coating or in the polymer composition comprises nanoparticles of cerium dioxide in combination with at least one other metal oxide.

The ratio of the other metal oxide to cerium oxide is from 0.5:99.5 to 50:50, preferably 5:95 to 40:60 and more preferably 10:90 to 30:70. The other metal oxide is selected from oxides of Fe, Mn, Cu and Co, or any combination thereof.

In an example, the coating composition has a ratio of UV/HEV absorbing material to non-volatile organic components of the coating composition from 0.05:99.95 to 10.0:90.0, preferably from 0.1:99.9 to 8.0:92.0 and more preferably from 0.2:99.8 to 6.0:94.0. Similarly, the polymer composition has a ratio of UV/HEV absorbing material to non-volatile organic components of the polymer from 0.01:99.99 to 10.0:90.0, preferably from 0.05:99.95 to 8.0:92.0 and more preferably from 0.1:99.9 to 6.0:94.0.

The coating composition containing the UV/HEV absorbing material may be used to coat substrates formed of plastic, glass, stone, masonry, brick, concrete, metal or wood.

In order to form a coating incorporating modified cerium oxide nanoparticles the particles of modified cerium oxide may be dispersed in another medium, such as a solvent, thinner or resin. The particles may be dispersed in a monomer which is then polymerised to produce the coating, or they may be dispersed in a coating medium after polymerisation. The particles may be dispersed in the coating medium during manufacture, or at the end of the manufacturing process. The coating medium may be chosen so that it will always be applied with a thickness above a minimum value to ensure that the absorption is sufficient.

It will be appreciated that in addition to providing protection to the surface to which the coating is applied, the formulation of modified cerium oxide also provides protection against degradation caused by UV and HEV to other components of the coating. For example, where a coating comprises modified cerium oxide in addition to organic polymers, the presence of modified cerium oxide protects the organic polymers from degradation caused by UV and HEV. It may also act as a free radical scavenger, hence reducing the degradation of organic polymers caused by free radicals such as OH·.

In another embodiment, a coated substrate may be prepared by applying a primer (i.e. an organic coating composition containing relatively high concentration of the above additive, comprising a UV/HEV absorber) directly to a substrate and then optionally applying another organic coating composition that is substantially free of the additive (or has much lower levels of the additives) as a topcoat.

In an example, such a primer coating composition has a ratio of UV/HEV absorbing material to non-volatile organic components of the primer coating composition from 6.0:94.0 to 99.0:1.0, preferably from 10.0:90.0 to 90:10 and more preferably from 15.0:85 to 85:15.

In an example, a substrate coated with the primer coating composition described above has a primer coating thickness from 0.1 to 40 microns, preferably from 0.5 to 30 microns and more preferably from 1 to 25 microns. A substrate coated with a primer coating and then subsequently coated with a topcoat has a thickness of, for example, from 1 to 500 microns.

In another embodiment, a coated substrate is prepared by applying an aqueous or non-aqueous dispersion of the additive, described above, by itself onto a substrate and allowing the applied additive coating to dry at room temperature, or at elevated temperatures, and then optionally applying another organic coating composition that is substantially free of the additive (or has much lower levels of the additives) as a topcoat. The drying temperatures can be determined by the nature of substrate to be coated by methods known in the technical field.

In an example, a substrate is prepared by applying an aqueous or non-aqueous dispersion of an additive to a substrate. A substrate coated with the additive has an additive coating thickness from 0.005 to 5.0 microns, preferably from 0.01 to 3.0 microns and more preferably from 0.02 to 2 microns. A substrate coated with the additive and then subsequently coated with a topcoat has a thickness from 1 to 500 microns.

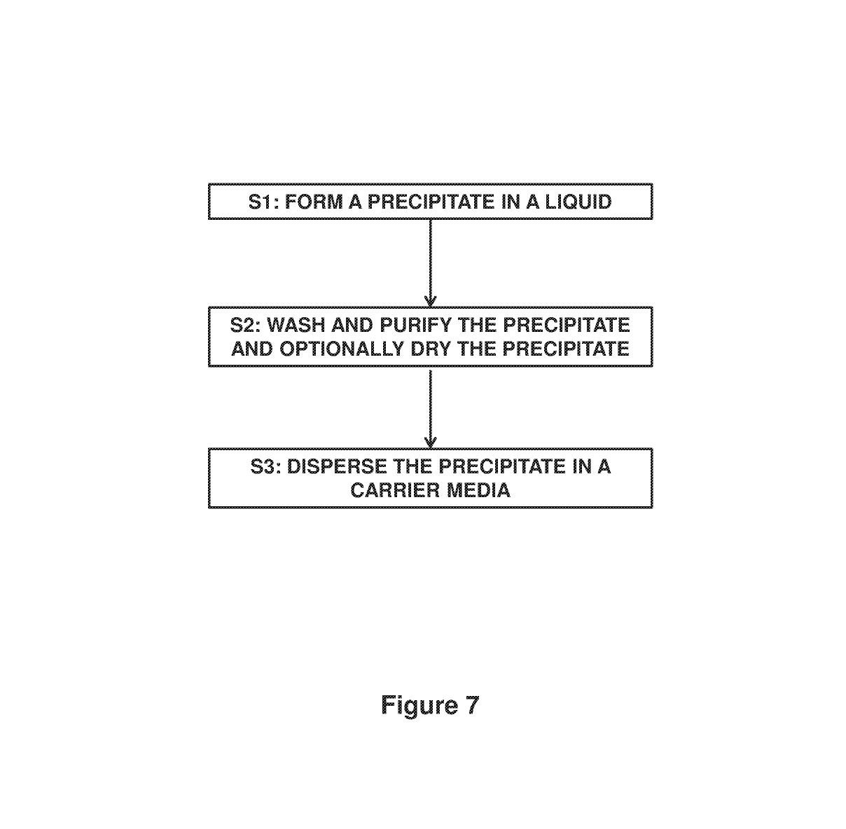

A method of manufacture of an additive for incorporation into a coating comprising nanoparticles of cerium oxide in combination with at least one other metal oxide will now be described with reference to FIG. 7. The additive in this example has a total absorption of light between 400 nm and 500 nm of greater than 10%. The following method is provided by way of example only; as discussed above, the nanoparticles may be formed in a variety of ways.

Step 1: 0.008 mol of Ce(NO₃)₃·6H₂O and 0.002 mol of FeCl₃·6H₂O were dissolved in 200 ml of de-ionized water and stirred for 30 minutes.

Step 2: Under stirring, ammonia aqueous solution was slowly added to the solution until the pH reached 9.0. A gel-like precipitate formed and the mixture was stirred fora further 60 minutes.

Steps 1 and 2 result in a precipitate formed in a liquid (S1).

Step 3: The resulting precipitate was separated and washed with de-ionized water three times. The washed and purified precipitate may optionally also be dried (S2).

Step 4: The resulting precipitate was then dispersed in a carrier media to form a nanoparticle dispersion additive (S3).

In order to perform a UV absorbance test, the following steps were carried out using the dispersion of Step 4:

Step 5: The Ce_{0.8}Fe_{0.2}O₂ particles dispersion additive was then diluted (using the same carrier as in Step 4) to a concentration of 0.01 w/v % in order to perform a UV absorbance test.

Step 6: UV absorbance characteristics were obtained at a scan speed of 600 nm/min and a path length of 10 mm.

It will be appreciated by the person skilled in the art that various modifications may be made to the above described embodiments without departing from the scope of the present invention. For example, nanoparticles of CeO₂ and other metal oxide may be dispersed in a coating, a polymer material, or in the matrix of a composite. Composites may include carbon fibre reinforced plastics, glass reinforced plastics, thermoset composites and plywood. The resultant material may have a total absorption of at least 10% of light between 400 nm and 500 nm.

“Light” is used herein to describe electromagnetic radiation of various wavelength bands. It will be appreciated that “light” as used herein may not necessarily refer to visible light, except where specified.

CeO₂ “modified” with or “combined” with another metal oxide (or variations thereof) is used herein to describe any of doping, coating and mixing. Doping is the incorporation (which may be interstitial or the direct replacement of a Ce atom) of another metal oxide in the cerium oxide crystal lattice. Coating in this context means that a CeO₂ particle has at least a partial surface coating of another metal oxide. Mixing means a mixture of discrete CeO₂ particles and discrete metal oxide particles. The composition of CeO₂ mixed with another metal oxide may also refer to a combination of two or more of the above. Due to the small size of nanoparticles, it may not be possible to confirm whether a composition comprises CeO₂ particles which are doped, coated or mixed with another metal oxide.

It will also be appreciated that similar results may be achieved by incorporating nanoparticles of cerium oxide and other metal oxides into other materials such as polymers. A polymer can be developed in a similar manner such that a combination of thickness, concentration and constitution of nanoparticles together provides the necessary absorbance of both UV and HEV light.

1. A coating or polymer composition containing UV/HEV absorbing material, and having a ratio of electromagnetic radiation absorption at 450 nm to that at 320 nm of greater than 5%.

2. (canceled)

3. The coating or polymer composition as claimed in claim 1, wherein the UV/HEV absorbing material comprises nanoparticles of cerium dioxide in combination with at least one other metal oxide.

4. The coating or polymer composition as claimed in claim 3, wherein the ratio of the other metal oxide to cerium oxide is from 0.5:99.5 to 50:50.

5. (canceled)

6. A coating or polymer composition having a ratio of UV/HEV absorbing material to non-volatile organic components of the coating composition from 0.05:99.95 to 10:90.

7. A substrate coated with the coating or polymer composition of claim 1.

8. The substrate as claimed in claim 7, wherein the substrate is one of: plastic, glass, stone, masonry, brick, concrete, wood, metal, textile, composite.

9. A UV/HEV absorbing material configured such that, when incorporated into a coating, a ratio of the coating's electromagnetic radiation absorption at 450 nm to that at 320 nm is greater than 5%.

10. The UV/HEV absorbing material as claimed in claim 9, comprising nanoparticles of cerium dioxide in combination with at least one other metal oxide.

11-13. (canceled)

14. An additive for incorporation into a coating or polymer, comprising nanoparticles of cerium oxide in combination with at least one other metal oxide, the additive configured so that the coating when applied to a surface, or the polymer, has a total absorption of at least 10% of electromagnetic radiation in a wavelength band between 400 nm and 500 nm.

15-16. (canceled)

17. The additive as claimed in claim 14, wherein the total absorption of the coating when applied to the surface or the total absorption of the polymer is:
at least 90% of electromagnetic radiation in a wavelength band between 300 nm and 400 nm, and
at least 10% of electromagnetic radiation in a wavelength band between 400 nm and 500 nm.

18. (canceled)

19. The additive as claimed in claim 14, wherein cerium oxide in combination with at least one other metal oxide is present in the range of −1 wt % to 90 wt %, and wherein the other metal oxide is at least 0.5% of the total metal oxide mixture.

20. (canceled)

21. The additive as claimed in claim 14, wherein the resultant coating or polymer is not colourless, or is substantially transparent.

22. (canceled)

23. The coating or polymer composition as claimed in claim 3, wherein the at least one other metal oxide is selected from iron oxide, copper oxide, manganese oxide, cobalt oxide, or any combination thereof.

24. The additive as claimed in claim 14, wherein the nanoparticles have an average size in the range of 1 nm to 500 nm.

25. (canceled)

26. A coating comprising the additive of claim 14, the coating designed for application with an intended thickness between 0.1 and 500 μm.

27. (canceled)

28. The coating as claimed in claim 26, wherein cerium oxide in combination with at least one other metal oxide is present in the coating in the range 0.05 wt % to 10 wt %.

29-31. (canceled)

32. A polymer comprising the additive of claim 14.

33-36. (canceled)

37. A primer coating composition having a ratio of UV/HEV absorbing material to non-volatile organic components of the primer coating composition from 6:94 to 99:1.

38. A substrate coated with the primer coating composition of claim 37, the primer coating composition having a primer coating thickness from 0.1 to 40 microns.

39. (canceled)

40. A substrate prepared by application of an aqueous or non-aqueous dispersion of the additive as claimed in claim 19 to the substrate.

41-42. (canceled)
